(19) United States
(12) Patent Application Publication
(10) Pub. No.: US 2010/0017321 A1
(43) Pub. Date: Jan. 21, 2010

(54) Adaptive Implied Spread Matching

(75) Inventors: Paul Joseph Callaway, Chicago, IL (US); Barry Lee Galster, Chicago, IL (US); Neil Steuber, Evanston, IL (US); John Jacob Siddall, Chicago, IL (US)

Correspondence Address: BANNER & WITCOFF, LTD.,;ATTORNEYS FOR CLIENT NO. 006119, 10 SOUTH WACKER DRIVE, SUITE 3000, CHICAGO, IL, 60606, US

(73) Assignee: Chicago Mercantile Exchange, Inc., Chicago, IL (US)

(21) Appl. No.: 12/176,130

(22) Filed: Jul. 18, 2008

(51) Int. Cl. G06Q 40/00

(52) U.S. Cl. 705/37

(57) ABSTRACT

Systems and methods for determining implied spreads are provided. An example includes receiving a new order for a financial instrument and determining if the new order in combination with pending orders creates an implied spread. The implied spread may be submitted with information to facilitate matching the legs of the implied spread using the new order. The detection of the implied spread may be performed outside of a match engine; thus, permitting the detection to occur in parallel and apart from the operation of the match engine.

### TECHNICAL FIELD

The present invention relates to systems and methods that are utilized in connection with the electronic trading of financial instruments. More particularly, implied spread financial transactions are determined using a distributed enhanced approach.

### DESCRIPTION OF THE RELATED ART

Traders often desire to trade multiple financial instruments in combination. Each component of the combination is called a leg. Traders can define the combination (e.,g an exchange-defined combination) and submit orders for each leg or in some cases can submit a single order for multiple financial instruments. Such orders may be called a strategy order, a spread order, or a variety of other names. The counter party orders that are matched against such a combination order may be individual, “outright” orders or may be part of other combination orders. In the case of spread orders, the matching system may imply the counter party order by using multiple orders to create the counter party order. Examples of spreads include implied IN, implied OUT, 2nd- or multiple-generation, crack spreads, straddle, strangle, butterfly, and pack spreads.

Implied IN spread orders are derived from existing outright orders in individual legs. Implied OUT outright orders are derived from a combination of an existing spread order and an existing outright order in one of the individual underlying legs. Implied orders can fills in gaps in the market and allow spreads and outright futures traders to trade in a product where there would otherwise have been little or no available bids and asks. Thus, the liquidity of the product is enhanced by the use of implied orders.

A spread is an order for the price difference between two contracts. This results in the trader holding a long and a short position in two or more related futures or options on futures contracts, with the objective of profiting from a change in the price relationship. A butterfly spread is an order for two inter-delivery spreads in opposite directions with the center delivery month common to both spreads. A calendar spread, also called a intra-commodity spread, for futures is an order for the simultaneous purchase and sale of the same futures contract in different contract months. (i.e., buying a September CME S&P 500® futures contract and selling a December CME S&P 500 futures contract). A crush spread is an order, usually in the soybean futures market, for the simultaneous purchase of soybean futures and the sale of soybean meal and soybean oil futures to establish a processing margin. A crack spread is an order for a specific spread trade involving simultaneously buying and selling contracts in crude oil and one or more derivative products, typically gasoline and heating oil. Oil refineries may trade a crack spread to hedge the price risk of their operations, while speculators attempt to profit from a change in the oil/gasoline price differential.

A straddle is an order for the purchase or sale of an equal number of puts and calls, with the same strike price and expiration dates. A long straddle is a straddle in which a long position is taken in both a put and a call option. A short straddle is a straddle in which a short position is taken in both a put and a call option. A strangle is an order for the purchase of a put and a call, in which the options have the same expiration and the put strike is lower than the call strike, called a long strangle. Also the sale of a put and a call, in which the options have the same expiration and the put strike is lower than the call strike, called a short strangle. A pack is an order for the simultaneous purchase or sale of an equally weighted, consecutive series of four futures contracts, quoted on an average net change basis from the previous day's settlement price. Packs provide a readily available, widely accepted method for executing multiple futures contracts with a single transaction. A bundle is an order for the simultaneous sale or purchase of one each of a series of consecutive futures contracts. Bundles provide a readily available, widely accepted method for executing multiple futures contracts with a single transaction.

By linking the spread and outright markets, implied spread trading increases market liquidity. For example, a buy in one contract month and an offer in another contract month in the same futures contract can create an implied market in the corresponding calendar spread. An exchange may match an order for a spread product with another order for the spread product. Some existing exchanges attempt to match orders for spread products with multiple orders for legs of the spread products. With such systems, every spread product contract is broken down into a collection of legs and an attempt is made to match orders for the legs. Examples of implied spread trading includes those disclosed in U.S. patent application Ser. No. 10/986,967, entitled “Implied Spread Trading System,” which is incorporated herein by reference.

For example, implied IN spreads may be created from existing outright orders in individual contracts where an outright order in a spread can be matched with other outright orders in the spread or with a combination of orders in the legs of the spread. An implied OUT spread may be created from the combination of an existing outright order in a spread and an existing outright order in one of the individual underlying leg. Implied IN or implied OUT spread may be created when an electronic match system simultaneously works synthetic spread orders in spread markets and synthetic orders in the individual leg markets without the risk to the trader/broker of being double filled or filled on one leg and not on the other leg.

Large exchanges typically have order books for numerous spread products and legs of the spread products. However, the identification and processing of potential implied spreads inside electronic trade systems consumes valuable processing resources that could otherwise be used to process outright orders. In a typical central limit order book implementation, the system component for receiving electronic trades from users appears as a single processing thread with a single point of control. In such an implementation, there is a requirement that one order matches only another order, and does not result in two competing processes both matching different orders against a single order. Therefore, implementations have been limited in such trading systems.

Therefore, there exists a need for enhanced systems and methods for identifying, executing, and disseminating implied spreads.

### SUMMARY OF THE INVENTION

Aspects of the invention overcome at least some of the above problems and limitations by providing multi-tiered systems and methods for detecting and executing implied spreads, and disseminating implied markets to a user community.

Systems and methods for determining implied spreads are provided. An example includes receiving a new order for a financial instrument and determining if the new order in combination with pending orders creates an implied spread. The implied spread may be submitted with information to facilitate matching the legs of the implied spread using the new order. The detection of the implied spread may be performed outside of a match engine; thus, permitting the detection to occur in parallel and apart from the operation of the match engine.

Furthermore, a match engine in accordance with aspects of the invention may use a search list to compare with the financial instrument of the new order. For those new orders that are found in the search list, the match engine may determine if the new order in combination with pending order(s) creates an implied spread. In some embodiments, the search list and a collection of needed orders may be updated to further refine the selection of orders for analysis in determining implied spreads.

In some embodiments, aspects of the invention may be implemented on a computer-readable medium, for example, by storing computer-executable instructions or modules, or by utilizing computer-readable data structures. Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

Aspects of the invention may take physical form in certain parts and steps, embodiments of which will be described in detail in the following description and illustrated in the accompanying drawings that form a part hereof, wherein:

FIG. 1 shows a computer network system that may be used to implement aspects of the invention;

FIG. 2 shows a system that may be used to match orders in accordance with an embodiment of the invention;

FIG. 3 illustrates a method for identifying implied spreads, in accordance with an embodiment of the invention; and

FIG. 4 shows a possible implied spread that consists of orders for a butterfly spread, two calendar spreads, and outright orders in accordance with an embodiment of the invention.

### DETAILED DESCRIPTION

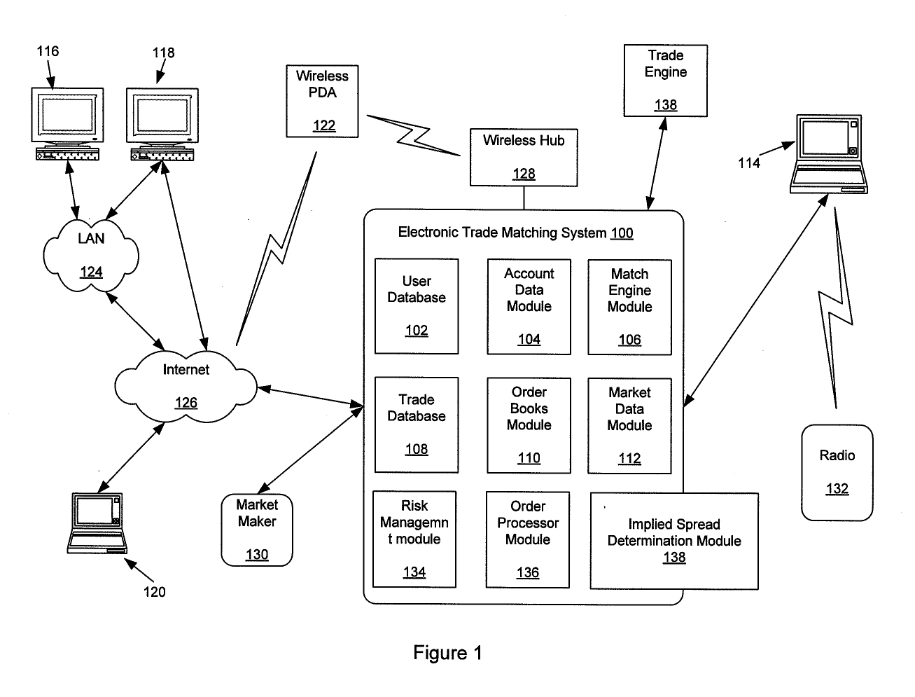

The present invention may take physical form in certain parts and steps, embodiments of which will be described in detail in the following description and illustrated in the accompanying drawings that form a part hereof. Aspects of the present invention may be implemented with computer devices and computer networks that allow users to exchange trading information. An illustrative trading network environment for implementing trading systems and methods is shown in FIG. 1.

An exchange computer system 100 receives orders and transmits market data related to orders and trades to users. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

A match engine module 106 is included in exchange computer system 100 to match bid and offer prices. Match engine module 106 may be implemented with software that executes one or more algorithms for, among other things, matching bids and offers. The match engine module 106 executes matching trades and reports on the last price for a financial instrument. The electronic match engine (i.e., match engine module) is described in greater detail below.

Exchange computer system 100 may also include an implied spread determination module 138. The implied spread determination module 138 may be used to determine if an order in combination with one or more pending unmatched orders (i.e., resting orders) in an order book creates an implied spread. The implied spread determination module 138 may perform the determination in parallel with and apart from the electronic match engine 106 in the exchange. Furthermore, as graphically depicted in FIG. 1, the implied spread determination module 138 may be located inside or outside the exchange computer system 100. For example, the implied spread determination module 138 may be located in a remote computer system 120 outside the exchange computer system 100. In another embodiment, the module 138 may have multiple instances running inside and outside the exchange. One skilled in the art will recognize that the implied spread determination module 138 may be implemented using programming code (e.g., C++, C, Java, etc.) and executed on a processor located in a computing device. The programming code may include common elements of software programming, such as “for loops”, “do-while loops”, function calls, if-else syntax, “switch” syntax, and other well known elements. Similar such programming code may be found in the various other modules and computer-readable instructions described throughout the disclosure.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer through a communication interface using a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. Trade engine 138 may be configured to process orders for instruments associated with another exchange or third party electronic trade matching system. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

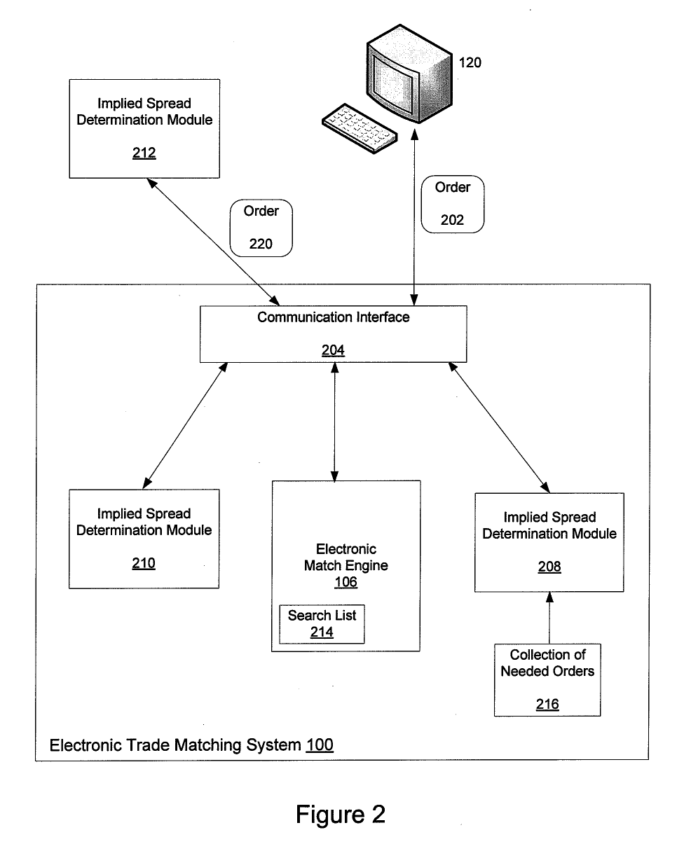

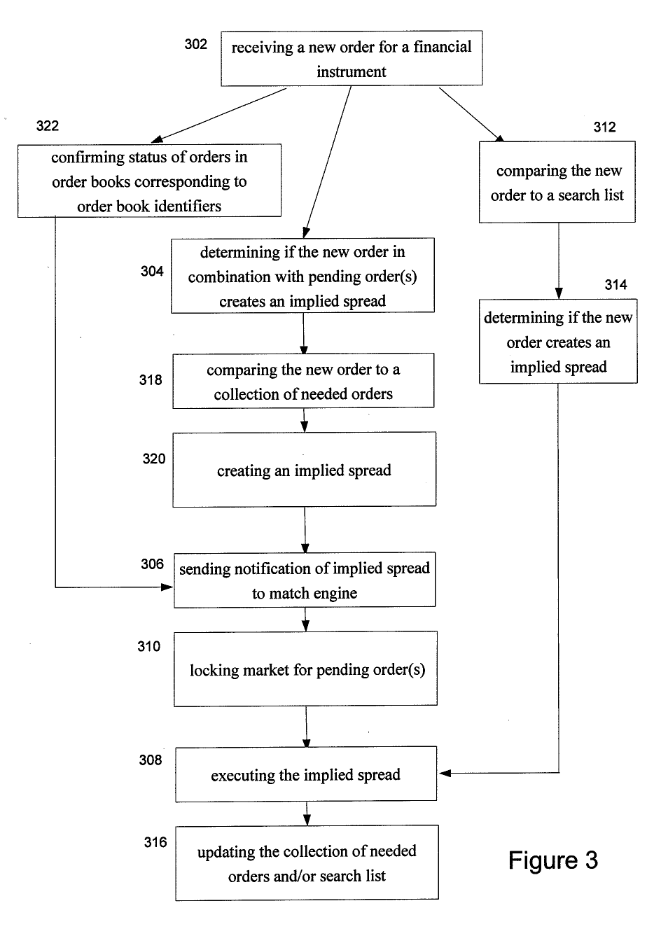

FIG. 2 shows a system that may be used to match orders in accordance with an embodiment of the invention. Meanwhile, FIG. 3 shows a method for determining implied spreads in accordance with various embodiments of the invention. A new order 202 for a financial instrument is received at an exchange computer system 200. The new order 202 may be an outright order for a single futures contract or any other financial product (e.g., an options contract, a derivative product, security, bond, etc.) Alternatively, the new order 202 may be a spread order with a butterfly, crack, or other configuration.

The new order 202 may be received (in step 302) at communication interface 204 in electronic trade matching system 100. In one embodiment, the communication interface 204 may be an input/output (I/O) port on a communications card (e.g., an Ethernet card) on a computing device at the exchange computer system 100. Alternatively, the communication interface 204 may be in communication with a user's computing device 120 that permits the user to enter/select an order 220. One skilled in the arts will appreciate that the communication interface 204 may be used to communicate with a variety of devices and/or modules inside or outside an exchange.

The new order may be sent to an implied spread determination module 208 to determine if the new order in combination with one or more pending orders creates an implied spread. Meanwhile, the new order 202 may also be nearly simultaneously submitted to the electronic match engine 106 for processing. As described in greater detail in commonly assigned, U.S. patent application Ser. No. 11/617,915 (Attorney Docket No. 006119.00082), entitled “Template Based Matching,” which is herein incorporated by reference in its entirety, match engine module 106 may attempt to match new order 202 to data included in a collection of almost matched orders and pending orders included in various order books. The collection of almost matched orders and/or various order books may be stored in a memory accessible to a microprocessor used to implement a match engine.

Sometime during or after the time the electronic match engine 106 receives the new order, the implied spread determination module 208 may perform in parallel the step of determining if any implied spreads are created using the new order 202. Some benefits of such an embodiment include reduced match engine 106 workload and quicker response times from match engine 106. In addition, as depicted in FIG. 1 and FIG. 2, the implied spread determination module may be various locations. For example, an implied spread determination module 212 may executed at a remote computer outside the exchange. The remote computer may be a computer located physically outside an exchange, but controlled by the exchange. Alternatively, the remote computer may be a trader's computer 120. In yet another example, the implied spread determination module 210 may be running in a processing thread on a computer located inside the exchange and running in parallel with one or more other implied spread determination modules 208. Therefore, numerous implied spread determination modules 208, 210 may be running in parallel with each other (e.g., different modules may each be searching some portion or depth of the possible implied space). Moreoever, the implied spread determination modules 210, 208, 212 may be running simultaneous with the electronic match engine 106. At least one benefit of such a parallel processing distributed architecture is the greater computational power available at a given time.

The implied spread determination module 138 may determine (in step 304) if any implied spreads are created using the new order 202. In one embodiment, order books are analyzed to generate a collection of needed orders 216 that each when combined with one or more existing orders meet the requirements of one of the acceptable trade templates. Trade templates are discussed in greater detail in commonly assigned, U.S. patent application Ser. No. 11/617,915 (Attorney Docket No. 006119.00082), entitled “Template Based Matching,” which was previously incorporated by reference in its entirety herein. New orders are compared (in step 318) to orders in the collection of needed orders 216. If the new order matches one of the needed orders, the implied spread determination module 208 creates an implied spread.

The implied spread created (in step 320) by the implied spread determination module 208 may comprise multiple legs. For example, the implied spread may include a first corresponding to the new order and a second leg corresponding to a pending order. In one example, the new order may be the order that completes the unmatched leg of an implied spread awaiting a match. The number of legs in the implied spread may be dependent on the resources (e.g., amount of processing power and time) available to the implied spread determination module 208 to attempt to identify possible implied spreads.

After the implied spread determination module 208 determines that an implied spread exists, a notification may be sent (in step 306) through a communication interface 204 to the electronic match engine 106 informing the engine of the matching combination. The notification may comprise order book identifiers that permit the matching engine to, in one embodiment, verify that all legs of the implied spread are valid. For example, the identifiers may be used to check the appropriate order books to verify (in step 322) that the appropriate resting orders are still unmatched. One skilled in the art will appreciate that a communication interface 204 may include an input/output (I/O) port on a communications card (e.g., an Ethernet card) on a computing device at the exchange computer system 100. Alternatively, information may be sent through the communication interface 204 to an output device (e.g., a display monitor) to alert a user (e.g., manager) of an exchange that an implied match exists so the user may respond accordingly.

Using the information provided in the notification, in step 308 the electronic match engine 106 matches (e.g., executes) all of the multiple legs of the implied spread. The plurality of trades that match the legs of the implied spread may be contemporaneously executed such that all of the trades are executed before a material change in the appropriate markets. The abundance of processing power at the electronic match engine 106 is at least one factor that permits the matching of the legs of the implied spread with minimal or no legging risk. For example, after an implied spread determination module 208 has identified the corresponding legs of an implied transaction, the electronic match engine 106 may execute the implied transaction inline without requiring a locking of the markets involved. In alternative embodiments, an exchange may lock (in step 310) one or more markets for the orders involved to eliminate legging risk.

As explained earlier, the electronic match engine 106 may be configured to determine if a new order 202 in combination with one or more pending orders for financial instruments creates an implied spread. In some embodiments, the electronic match engine 106 may limit the determination to only those financial instruments located in a search list 214. The search list 214 may comprise a plurality of financial instruments that are to be monitored for determining implied spreads. The new order 202 may be compared (in step 312) to the search list 214 before determining (in step 314) if an implied spread is created. At least one benefit of such an embodiment is that it allows an exchange to restrict the electronic match engine 106 from searching a potentially unlimited number of new orders for implied spreads by focusing it on those financial instruments of new orders that are more conducive to a an implied spread.

Furthermore, in one embodiment in accordance with aspects of the invention, the search list may be updated (in step 316) based on the determining occurring in an implied spread determination module 138. As such, the search list is an adaptive list that allows electronic match engine 106 to spend resources trying to detect implied spreads where there is a higher probability of finding them. This may be determined based on past success, market conditions, and/or through monitoring activity of the implied spread determination module 138 and/or the electronic match engine 106 itself.

Likewise, the operation of an implied spread determination module 138 may be adjusted based on prior findings of implied spreads. For example, the collection of needed orders 216 may be updated (in step 316) based on the determination of implied spreads occurring in the implied spread determination module 208. As such, the collection of needed orders 216 may be dynamically adjusted to identify those financial instruments that have a higher probability of contributing to an implied spread. Like the search list 214, the adjustment may be based on past success, market conditions, and/or through monitoring activity. In one embodiment in accordance with various aspects of the invention, an implied spread determination module 138 may include its own search list. Such a search list may operate similar to search list 214 to enhance the operation of the implied spread determination modules 208, 210, 212.

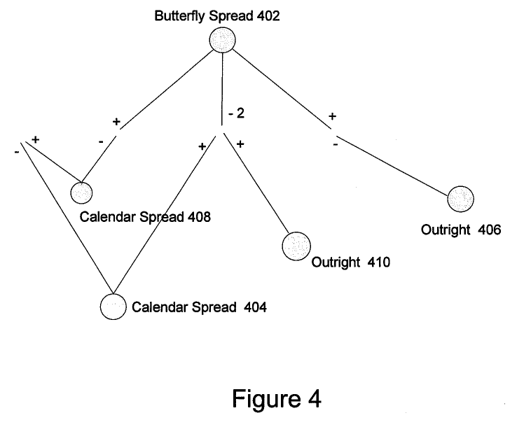

Referring to FIG. 4, an implied spread determination module 208 in accordance with various aspects of the invention may identify an implied spread for a new order 410 using pending spread orders 402, 404, 408, and an outright order 406. The new order may be an order to buy 9700 oil future call contracts. The implied spread determination module 138 may calculate that the legs of butterfly spread 402 may be combined with the legs of calendar spread 408 and calendar spread 404. In addition, the module 138 may calculate that one of the two remaining unmatched legs of the butterfly spread 402 may be filled by a pending outright order 406. The remaining unmatched leg may match an order to sell 9700 oil future call contracts. Therefore, the implied spread determination module 138 may send a notification to the electronic match engine 106 indicating that the combination of the pending orders 402, 404, 406, and 408 and new order 410 complete a match. The notification may include identifers directing the match engine 106 to the appropriate order books to find the appropriate pending orders.

Such a notification may, in one embodiment in accordance with aspects of the invention, include order book identifiers without also including a copy of the orders. Since the best priced orders on an order book will be used for matching, the electronic match engine 106 does not necessarily require a copy of the order itself. Moreover, since new orders may arrive during any period of time, the system may further check the order book to identify any additional orders. In addition, such an embodiment allows that only possess aggregate book information to take part in the process. For example a customer who only knows the number and quantity of orders present at a price level in an order book may be able to detect and transmit a possible implied without knowing the detailed information about orders on the book. Since the implied spread determination module 138 is running in parallel with the match engine 106, the module 138 may be able to run through greater combinations of orders to determine if an implied spread may be formed.

In yet another example in accordance with various aspects of the invention, a user external to the exchange computer system 100, such as a user of a trading terminal 120, 118, 116, may monitor the market and order books to calculate an implied spread. The terminal 120 may send a new order 220 (e.g., an outright order, a synthetic spread order, etc.) to the exchange that uses the implied spread to obtain an advantageous trade price. The new order may be in a recognized format (e.g., the FIX/FAST format) and include information in its message format that facilitates matching by an electronic match engine 106 of the new order 220 with the one or more pending orders. That information may include multiple order book identifiers or other information useful to the match engine 106 to match the order 220. In one embodiment, the order may be marked as “Fill and Kill” or “Fill or Kill;” thus, further reducing the customer's risk by ensuring that the order does not rest on the order book if the implied matching possibility no longer exists.

The match engine 106 may, in some embodiments, verify the information that facilitates matching by confirming the status of pending orders that will be matched against the legs of the implied spread. The exchange computer system 100 may perform the verifying in the match engine 106 itself, or alternatively, delegate this activity to a implied spread determination module 208 where the verifying may occur in a separate thread running in parallel with the match engine 106. If the verification finds the implied spread to be valid, then a notification of the implied spread may be sent to the match engine 106 for executing all of the legs of the implied spread against the pending orders identified in the order 202. At least one advantage of executing all of the legs of the implied spread in a nearly simultaneous manner is that there is miniscule slippage risk to the user. In some embodiments, a limit may be placed on the number of legs that may be submitted in an implied spread in order to guarantee that the legging risk is averted.

The present invention has been described herein with reference to specific exemplary embodiments thereof. It will be apparent to those skilled in the art that a person understanding this invention may conceive of changes or other embodiments or variations, which utilize the principles of this invention without departing from the broader spirit and scope of the invention as set forth in the appended claims.

We claim:

1. A method comprising:
receiving a new order for a financial instrument;
determining if the new order in combination with one or more resting orders creates an implied spread, the determining occurring in parallel with and apart from an electronic match engine in an exchange, and the implied spread comprising multiple legs, a first of the multiple legs corresponding to the new order and a second leg of the multiple legs corresponding to a resting order of the one or more resting orders; and
sending a notification of the implied spread to the electronic match engine for matching, the notification comprising order book identifiers, the matching including executing all the multiple legs of the implied spread.

2. The method of claim 1, further comprising:
comparing the financial instrument of the new order to a search list, the search list comprising a plurality of financial instruments to be monitored for implied spreads;
determining, by the electronic match engine in the exchange, if the new order in combination with one or more resting orders for financial instruments in the search list creates an implied spread; and
updating the search list based on the determining occurring in parallel apart from the electronic match engine.

3. The method of claim 1, where the determining includes:
comparing the new order to a collection of needed orders which are generated based on requirements of acceptable trade templates; and
if the new order matches a needed order of the of the collection of needed orders, then creating the implied spread, where the needed order is a resting order.

4. The method of claim 3, further comprising:
updating the collection of needed orders based on the determining occurring in parallel apart from the electronic match engine.

5. The method of claim 1, where the new order is a synthetic implied spread order comprising information to facilitate matching by the electronic match engine of the synthetic implied spread order with the one or more resting orders, the information comprising the order book identifiers for use in the notification; where the determining includes verifying the information that facilitates matching of the synthetic implied spread order, including confirming status of orders in order books corresponding to the order book identifiers; and where the matching by the electronic match engine includes using the information of the implied spread order to facilitate matching.

6. The method of claim 1, the determining occurring in at least one remote computer outside the exchange and simultaneous with processing by the electronic match engine.

7. The method of claim 1, the determining occurring in at least one processing thread running in parallel with the electronic matching engine, the at least one processing thread running on a computer inside the exchange.

8. The method of claim 1, where the new order is an outright order for a futures contract.

9. The method of claim 1, where the new order is a spread order for a futures contract.

10. The method of claim 9, where the spread order is a crack spread.

11. The method of claim 1, where the new order is an outright order for an options contract.

12. A system comprising:
communication interface configured to receive a new order and to send a notification of an implied spread to an electronic matching device in an exchange;
implied spread determination module configured to determine if the new order and resting orders existing in order books create the implied spread, the determining occurring apart from the electronic match engine, and the implied spread comprising a first leg corresponding to the new order and a second leg corresponding to a resting order; and
the electronic match engine in the exchange configured to execute all legs of the implied spread.

13. The system of claim 12, the electronic match engine further configured to:
receive a notification of the implied spread, the notification comprising information to facilitate matching of all legs of the implied spread including a first order book identifier and a second order book identifier; and
match the first leg of the implied spread in a first order book corresponding to the first order book identifier, and the second leg of the implied spread in a second order book corresponding to the second order book identifier.

14. The system of claim 12, where the implied spread determination module is executing on at least one remote computer outside the exchange.

15. The system of claim 12, where the implied spread determination module is running in a processing thread in parallel with the electronic match engine, the processing thread running on a computer inside the exchange.

16. The system of claim 12, the electronic match engine including a search list comprising a plurality of financial instruments as candidates for implied spreads, where the electronic match engine is further configured to:
determine if the new order and resting orders for financial instruments in the search list create an implied spread; and
update the search list based on the determining in the implied spread determination module.

17. A method comprising:
receiving an outright order for a financial instrument, the outright order comprising information to facilitate matching by the electronic match engine of the outright order with the one or more resting orders, the information to facilitate matching comprising order book identifiers;
verifying the information that facilitates matching, including confirming status of orders in order books corresponding to the order book identifiers, the verifying occurring in a separate thread running in parallel with an electronic match engine in an exchange,
if the outright order in combination with one or more resting orders in the order books creates an implied spread, then sending notification of the implied spread to the electronic match engine for matching, the notification comprising order book identifiers, the matching including executing all legs of the implied spread.

18. The method of claim 17, where the executing of all legs of the implied spread occurs with no slippage risk to a user.

19. The method of claim 18, where the outright order is for an options contract.

20. A tangible computer-readable medium storing computer-executable instructions configured to perform a method comprising:
receiving an order for a financial instrument, the order comprising information to facilitate matching of the order by an electronic match engine with the one or more resting orders, the information to facilitate matching comprising order book identifiers;
confirming status of resting orders in order books corresponding to the order book identifiers, the confirming occurring in an electronic match engine in an exchange; and
matching in a nearly simultaneous manner all legs of the implied spread using the order book identifiers.
